(19) United States
(12) Patent Application Publication
(10) Pub. No.: US 2020/0250750 A1
(43) Pub. Date: Aug. 6, 2020

(54) SYSTEMS AND METHODS FOR AN ARTIFICIAL INTELLIGENCE TRAINED COMPUTING PLATFORM FOR PREDICTING VOLATILITY

(71) Applicant: Oanda Corporation, San Francisco, CA (US)

(72) Inventors: A. J. Remlinger, San Francisco, CA (US); Daniel James Walinsky, San Francisco, CA (US); Mateo Graziosi, San Francisco, CA (US)

(21) Appl. No.: 16/532,290

(22) Filed: Aug. 5, 2019

Related U.S. Application Data
(60) Provisional application No. 62/799,653, filed on Jan. 31, 2019.

(51) Int. Cl. G06Q 40/04; G06Q 30/02

(52) U.S. Cl. CPC G06Q 40/04; G06Q 30/0201; G06Q 30/0202

(57) ABSTRACT

Methods and systems for a volatility prediction are provided. The method includes receiving, via a graphical user interface, a first user input for a first currency. The method also includes receiving, via the graphical user interface, a second user input for a second currency. The method also includes receiving, via the graphical user interface, a third user input for a first time period. The method also includes determining, based on a technical indicator data associated with an exchange rate between the first and the second currency, a first volatility for the exchange rate. The method also includes determining, based on one or more economic events data, a second volatility for the exchange rate. The method also includes determining, based on a sentiment indicator associated with the exchange rate between the first and the second currency, a third volatility for the exchange rate. The method also includes determining, based on the first, second, and the third volatilities, a fourth volatility for the exchange rate at an end of the first time period. The method also includes predicting, based on the fourth volatility, one or more exchange rates between the first currency and the second currency at the end of the first time period. The method also includes causing the one or more exchange rates between the first currency and the second currency to be displayed on the graphical user interface.

### TECHNICAL FIELD

The present disclosure generally relates to a volatility prediction platform, and more specifically relates to prediction of volatility based on artificial intelligence trained models.

### BACKGROUND

Risks from fluctuations in exchange rates between two currencies may severely impact profitability of a transaction. Information regarding the volatility in the exchange rates may assist users in appropriately identifying future risks of the transaction. However, existing techniques fail to identify volatility in the future based on assumptions that the volatility of recent past will remain at the same level in the future, which can result in large discrepancies in the predicted volatility and actual volatility in the future, which further exacerbates the risks from the exchange rates between currencies.

### SUMMARY

The present disclosure provides for a volatility prediction platform that incorporates multiple sources of economic data to predict volatility at a certain time in the future.

Accordingly to one embodiment of the present disclosure, a computer-implemented method is provided. The method includes receiving, via a graphical user interface, a first user input for a first currency. The method also includes receiving, via the graphical user interface, a second user input for a second currency. The method also includes receiving, via the graphical user interface, a third user input for a first time period. The method also includes determining, based on a technical indicator data associated with an exchange rate between the first and the second currency, a first volatility for the exchange rate. The method also includes determining, based on one or more economic events data, a second volatility for the exchange rate. The method also includes determining, based on a sentiment indicator associated with the exchange rate between the first and the second currency, a third volatility for the exchange rate. The method also includes determining, based on the first, second, and the third volatilities, a fourth volatility for the exchange rate at an end of the first time period. The method also includes predicting, based on the fourth volatility, one or more exchange rates between the first currency and the second currency at the end of the first time period. The method also includes causing the one or more exchange rates between the first currency and the second currency to be displayed on the graphical user interface.

Accordingly to one embodiment of the present disclosure, a non-transitory computer readable medium is provided including instructions that, when executed by a processor, cause the processor to perform a method. The method includes receiving, via a graphical user interface, a first user input for a first currency. The method also includes receiving, via the graphical user interface, a second user input for a second currency. The method also includes receiving, via the graphical user interface, a third user input for a first time period. The method also includes determining, based on a technical indicator data associated with an exchange rate between the first and the second currency, a first volatility for the exchange rate. The method also includes determining, based on one or more economic events data, a second volatility for the exchange rate. The method also includes determining, based on a sentiment indicator associated with the exchange rate between the first and the second currency, a third volatility for the exchange rate. The method also includes determining, based on the first, second, and the third volatilities, a fourth volatility for the exchange rate at an end of the first time period. The method also includes predicting, based on the fourth volatility, one or more exchange rates between the first currency and the second currency at the end of the first time period. The method also includes causing the one or more exchange rates between the first currency and the second currency to be displayed on the graphical user interface.

According to one embodiment of the present disclosure, a system is provided that includes means for storing instructions, and means for executing the stored instructions that, when executed by the means, cause the means to perform a method. The method includes receiving, via a graphical user interface, a first user input for a first currency. The method also includes receiving, via the graphical user interface, a second user input for a second currency. The method also includes receiving, via the graphical user interface, a third user input for a first time period. The method also includes determining, based on a technical indicator data associated with an exchange rate between the first and the second currency, a first volatility for the exchange rate. The method also includes determining, based on one or more economic events data, a second volatility for the exchange rate. The method also includes determining, based on a sentiment indicator associated with the exchange rate between the first and the second currency, a third volatility for the exchange rate. The method also includes determining, based on the first, second, and the third volatilities, a fourth volatility for the exchange rate at an end of the first time period. The method also includes predicting, based on the fourth volatility, one or more exchange rates between the first currency and the second currency at the end of the first time period. The method also includes causing the one or more exchange rates between the first currency and the second currency to be displayed on the graphical user interface.

According to one embodiment of the present disclosure, a system is provided including a memory storing sequences of instructions, and a processor configured to execute the sequences of instructions, which when executed, causes the processor to perform receiving, via a graphical user interface, a first user input for a first currency. The execution of the sequences of instructions also causes the processor to perform receiving, via the graphical user interface, a second user input for a second currency. The execution of the sequences of instructions also causes the processor to perform receiving, via the graphical user interface, a third user input for a first time period. The execution of the sequences of instructions also causes the processor to perform determining, based on a technical indicator data associated with an exchange rate between the first and the second currency, a first volatility for the exchange rate. The execution of the sequences of instructions also causes the processor to perform determining, based on one or more economic events data, a second volatility for the exchange rate. The execution of the sequences of instructions also causes the processor to perform determining, based on a sentiment indicator associated with the exchange rate between the first and the second currency, a third volatility for the exchange rate. The execution of the sequences of instructions also causes the processor to perform determining, based on the first, second, and the third volatilities, a fourth volatility for the exchange rate at an end of the first time period. The execution of the sequences of instructions also causes the processor to perform predicting, based on the fourth volatility, one or more exchange rates between the first currency and the second currency at the end of the first time period. The execution of the sequences of instructions also causes the processor to perform causing the one or more exchange rates between the first currency and the second currency to be displayed on the graphical user interface.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate aspects of the subject technology, and together with the description serve to explain the principles of the subject technology. In the drawings:

FIG. 1 illustrates an example architecture for a volatility prediction.

FIG. 2 is a block diagram illustrating the example clients and servers from the architecture of FIG. 1 according to certain aspects of the disclosure.

FIG. 3 illustrates an example process for predicting volatility using the example server of FIG. 2.

FIG. 4 is a block diagram illustrating an example computer system with which the clients and servers of FIG. 2 can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

### General Overview

Various organizations are generally exposed to various levels of currency risks. These risks may significantly impact profitability of a transaction for at least one of the entities involved in a transaction. One of the major sources of risk in currencies is the volatility of an exchange rate between a first currency and a second currency in a currency pair. Generally, to offset this risk, various entities attempt to hedge the risks based on an expected volatility. Existing systems and methods attempt to determine a volatility level for the currency pair in the recent past and determine the volatility to remain at the same level in the future. However, such systems and methods fail to account for all the sources that may impact volatility of exchange rates between currencies in a currency pair.

The techniques, methods, and systems described herein address a technical problem of efficiently retrieving data from various data resource in an electronically exchange traded platform, which is a problem specifically arising in the realm of computer technology. The techniques, methods, and systems described herein address the technical problem by providing a technical solution also rooted in computer technology, namely by efficient data utilization associated with various factors that impact volatility.

### Example System Architecture

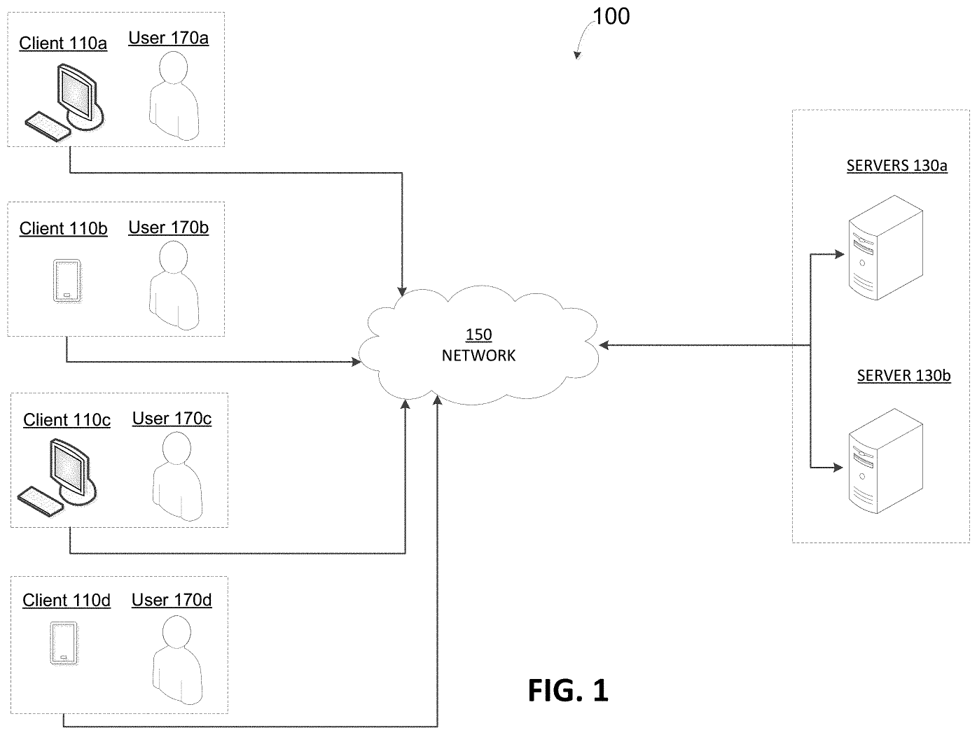

FIG. 1 illustrates an example architecture 100 for a volatility prediction platform that predicts volatility for a currency pair in response to a user input via graphical user interface. As described herein, a “trader user” is any entity that executes a currency trades. The architecture 100 includes clients 110a, 110b, 110c, 110d, generally referred to herein as clients 110, and servers 130a, 130b, generally referred to herein as servers 130 connected over a network 150. Users 170a, 170b, 170c, 170d, generally referred to herein as users 170, interact with respective clients 110 and transmit data, including instructions, to servers 130.

Servers 130 may be configured to be cloud computing servers that provide platform-as-a-service (PaaS) and/or software-as-a-service (SaaS) services. Examples of platforms and/or software hosted by the servers 130 include, but are not limited to, applications configured for predicting a volatility for a currency pair selected by a user 170, generally referred to herein as a “prediction application.” The platforms use data related to the users 170. Examples of data related to users 170 includes, but are not limited to, users 170 account information, such as user identifiers, and other preferences associated with the users 170, and the like. Preferences data associated with users 170 may be stored in a data storage unit of the server 130 or a data storage unit coupled to the server 130. In some implementations, for purposes of load balancing, multiple servers 130 may host the above described applications and data. The servers 130 can be any devices having an appropriate processor, memory, and communications capability for hosting applications including hosting applications as a service.

The clients 110 include one or more computing devices, including but not limited to, mobile devices (e.g., a smartphone or PDA), tablet computers, laptop computers, desktop computers, and/or other devices capable of running a volatility prediction application. In some implementations, the clients 110 may include a storage medium that includes logic to provide authentication of a user 170 credentials to provide access to the volatility prediction application. In some implementations, the volatility prediction application provided by the client 110 may be executable by one or more processors of the client 110. The volatility prediction application or instances of volatility prediction application may each individually be stored on media, such as flash memory, stead-state memory, removable media storage, or other storage media. In some implementations, instances of the volatility prediction application may be downloaded and stored on storage media of the clients 110. The clients 110 are configured to transmit data to the servers 130 in response to inputs received from users 170. In some implementations, clients 110 are configured to download data associated with the user 170 and stored on the servers 130, upon starting the instance of the volatility prediction application being hosted on the client 110.

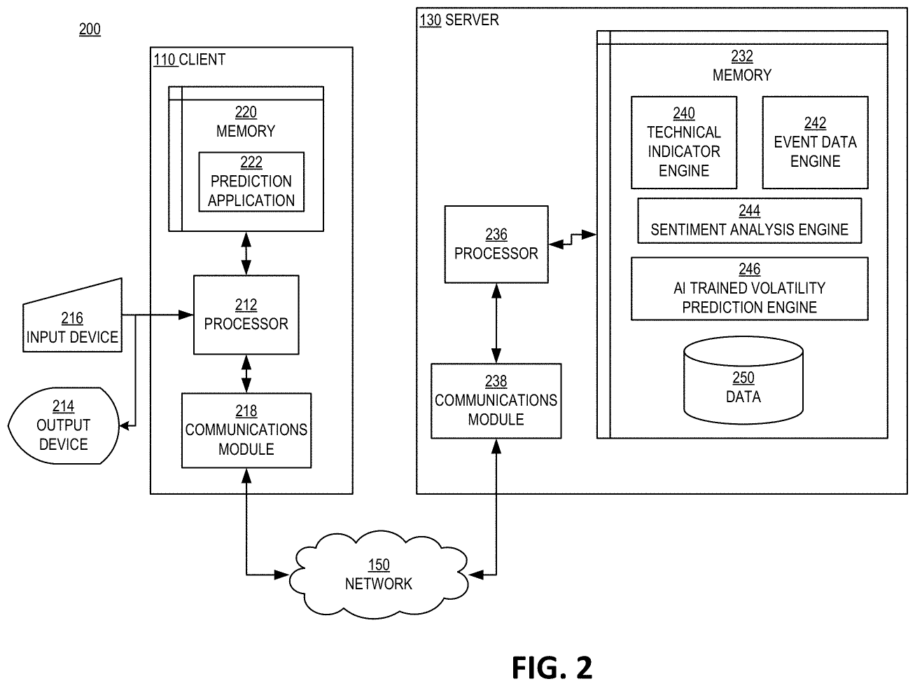

A volatility prediction application should be understood to include software code that the client 110 uses to provide an interface, such as a graphical user interface (GUI), with which a user interacts. A volatility prediction application may include software code that informs the client 110 of processor instructions to execute. A user 170 interacts with the volatility prediction application and the client 110 through user input/output (I/O) devices. The clients 110 may each execute a separate instance of a volatility prediction application. Additional details of clients 110 are described below with reference to FIG. 2.

The clients 110 and the servers 130 are communicatively coupled to each other over the network 150. The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

### Example System for Volatility Prediction Platform

FIG. 2 is a block diagram 200 illustrating an example server 130 and client 110 in the architecture 100 of FIG. 1 according to certain aspects of the disclosure. The client 110 and the server 130 are connected over the network 150 via respective communications modules 218 and 238. The communications modules 218 and 238 are configured to interface with the network 150 to send and receive information, such as data, requests, responses, and commands to other devices on the network. The communications modules 218 and 238 can be, for example, modems or Ethernet cards.

The server 130 includes a memory 232, a processor 236, and a communications module 238. The memory 232 of the server 130 includes a technical indicator engine 240, event data engine 242, sentiment analysis engine 244. The processor 236 of the server 130 is configured to execute instructions, such as instructions physically coded into the processor 236, instructions received from software in the memory 232, or a combination of both. The server 130 receives inputs from users 170 via clients 110 over the network 150. Examples of inputs received by the server 130 include, but are not limited to, receiving user input data related to user login information, such as a username, a password, and the like. User input data includes data related to inputs from a user that specify currencies for currency pairs for which the user desires prediction of volatility at a time period in the future. The server 130, via processor 236, may be configured to provide the user inputs to one or more other sub-components of the server 130, such as the technical indicator engine 240, the event data engine 242, the sentimental analysis engine 244, the artificial intelligence trained volatility prediction engine 246. The server 130, via processor 236, may be configured to store data received by the server 130 in a data storage unit included in the server 130, such as data storage unit 250, or in a data storage unit communicatively and/or operably coupled with the server 130. Examples of data received by the server 130 include, but are not limited to, exchange rate data for various currency pairs, trade execution data for various trader users or traders, trade execution data from various trading exchanges, economic event data, user input data.

The technical indicator engine 240 may be configured to retrieve or access exchange rate data between currencies of a currency pair from a data storage unit, such as a data storage unit 250, storing the exchange rate data between two currencies. As described above, the server 130 may receive historical exchange rate data for various currency pairs. The technical indicator engine 240 may be configured to retrieve exchange rate data over certain period of time. For example, the technical indicator engine may be configured to retrieve exchange rate data between two currencies of a currency pair over the past ten days. In some implementations, the technical indicator engine 240 may be configured to retrieve exchange rate data for a default historical period of time. In some implementations, the technical indicator engine 240 may be configured to retrieve exchange rate data based on a time period input from a user, such as user 170. For example, a user 170 may specify that they desire to receive volatility information for a currency pair thirty days in the future from the present day by providing as an input a time period that indicates that duration of time, and the technical indicator engine 240 may be configured to retrieve exchange rate data for the past number of days that corresponds with the time period provided, for example, thirty days.

The technical indicator engine 240 may be configured to generate one or more technical indicators based on the retrieved exchange rate data. Examples of technical indicators include, but are not limited to, average true range indicator, Bollinger band width indicators, force index indicator. The technical indicator engine 240 may be configured to generate certain encoded data based on the retrieved exchange rate data. In some implementations, the technical indicator engine 240 may be configured generate a certain score for a subset of the time period for which the exchange data is retrieved based on the change in the exchange rates between two currencies of a currency pair . For example, the technical indicator engine 240 may be configured to generate a volatility score for a day for a currency pair based on the change in the exchange rate from a previous day's closing exchange rate data to the current exchange rate data.

The technical indicator engine 240 may be configured to generate a volatility signal based on the one or more generated technical indicators. In some implementations, the technical indicator engine 240 may be configured to determine that the volatility will be high if one or more technical indicators indicate a change in exchange rates satisfies or is above a threshold change level. In some implementations, the technical indicator engine 240 may be configured to determine that the volatility will be low if the one or more technical indicators indicate a change in exchange rates satisfies or is below a threshold change level. In some implementations, the technical indicator engine 240 may be configured with one or more artificial intelligence models trained to identify whether volatility may increase, decrease, or remain within a threshold range over a certain time period in the future. In some implementations, the artificial intelligence models may be configured to receive as inputs the encoded data generated based on the technical indicators.

The event data engine 242 is configured to determine whether one or more economic events occur within a certain time period. In some implementations, the event data engine 242 may be configured to determine whether the events occur within a time period provided by a user, such as the user 170. In some implementations, the event data engine 242 may be configured to determine whether an economic event is a regularly or routinely occurring economic event or a rare economic event based on a set of rules that specify whether an economic event occurs regularly or routinely or is a rare economic event. The set of rules may be stored in a data storage unit included in the server 130, such as data storage unit 250, or in a data storage unit communicatively and/or operably coupled with the server 130. Examples of economic events may include, but are not limited to, non-farm payroll announcement, unemployment rate announcement, presidential elections, and the like. In some implementations, the event data engine 242 may be configured to determine whether a certain event classifies as a regular event or a rare event. In some implementations, the event data engine 242 may be configured to determine that an event is a regular event based on frequency at which the event occurs within a certain time period, such as in a year. For example, the event data engine 242 may be configured to track the number of times an event occurred within a certain time period, and if the number of times the event occurred satisfies a threshold amount, then the event data engine may classify the event as a regular event.

The event data engine 242 may be configured to determine how volatility of the exchange rate for a currency pair was affected when the event occurred previously. The event data engine may be configured to generate a volatility signal based on how the occurrence of the event affected volatility. In some implementations, the volatility signal may indicate whether volatility will be high, low, or moderate. In some implementations, the volatility signal may specify a certain value by which the volatility may change. In some implementations, the event data engine 242 may be configured to generate a weight value to assign to the volatility signal based on whether the event that occurred is a regular event or an irregular or rare event. The event data engine 242 may be configured to generate a high weight value or increase a weight value that satisfies a high threshold weight value if the event is a regular event. The event data engine 242 may be configured to generate a low weight value or decrease a weight value if the event that occurred is a rare event. By assigning different weight values to the volatility signals, the event data engine may improve the accuracy of a predicted volatility. The event data engine 242 may be configured to generated volatility signals using artificial intelligence trained models using event type of the event that occurred, and previously observed changes in volatility after the event occurred.

The sentiment analysis engine 244 may be configured to generate a volatility signal based on trading data related to currencies and currency assets. The sentiment analysis engine 242 may be configured to determine a type for a trader user, and may be configured to generate a volatility signal based on whether the type for the trader is an aggressive trader. In some implementations, the sentiment analysis engine 242 may be configured to determine whether a trader may be an aggressive trader or a conservative trader based on trading patterns of the trader user. In some implementations, the sentiment analysis engine 242 may be configured to determine whether a trader is an aggressive or a conservative trader based on a risk profile associated with the trader.

The sentiment analysis engine 244 may be configured to generate a volatility signal based on a change in assets owned by trader users within a certain time period. In some implementations, the sentiment analysis engine 244 may determine the type of the trader user and may determine whether the change in the assets owned by the trader user satisfies a threshold asset level. For example, if a trader identified as an aggressive trader increases the number of assets owned by the trader, then the sentiment analysis engine 244 may be configured to generate a volatility signal that indicates that the volatility will be high over a certain time period in the future. In some implementations, the sentiment analysis engine 244 may be configured to use artificial intelligence trained models to generate volatility signals using as inputs trader type, and trading data of the traders.

The artificial intelligence trained volatility prediction engine (“volatility prediction engine”) 246 may be configured to predict a volatility for the currency pair based on volatility signals generated by the technical indicator engine 240, event data engine 242, and/or sentiment analysis engine 244. The volatility prediction engine 246 may be configured to utilize one or more artificial intelligence trained models to predict volatility at a certain time period in the future. Examples of artificial intelligence trained models used by the volatility prediction engine 246 may include, but are not limited to, regressive, supervised machine learning models, such as decision trees, neural networks and the like. In some implementations, the volatility prediction engine receives as inputs to the one or more artificial intelligence trained models, the currency pair selected by the user, the various volatility signals and various data generated and/or determined at a previous time step or interval in the prediction of volatility. For example, the volatility prediction engine 246 may utilize a recurrent neural network model to predict volatility for a currency, and utilize as inputs certain state data or other data generated in the intermediate levels of the recurrent neural networks.

The client 110 includes a processor 212, the communications module 218, and the memory 220 that includes a volatility prediction application 222. The volatility prediction application 222 may be a streaming engine and/or simulation engine, or physically coded instructions that execute a volatility prediction application, which when executed presents graphical user interfaces (GUI) for logging into the application, providing inputs to the server 130, receiving messages from server 130. The client 110 also includes an input device 216, such as a keyboard, mouse, touchscreen and/or the like, and an output device 214, such as a display. The processor 212 of the client 110 is configured to execute instructions, such as instructions physically coded into the processor 212, instructions received from software in the memory 220, or a combination of both. The processor 212 of the client 110 executes instructions from the volatility prediction application 222 causing the processor 212 to transmit user inputs and data from the volatility prediction application 222 to the server 130 via the communications module 218. The user 170, via the prediction application 222, being executed on client 110, interacts with the technical indicator engine 240, the event data engine 242, the sentiment analysis engine 244, and the artificially trained volatility prediction engine 246.

The techniques described herein may be implemented as method(s) that are performed by physical computing device(s), as one or more non-transitory computer-readable storage media storing instructions which, when executed by computing device(s), cause performance of the method(s), or, as physical computing device(s) that are specially configured with a combination of hardware and software that causes performance of the method(s).

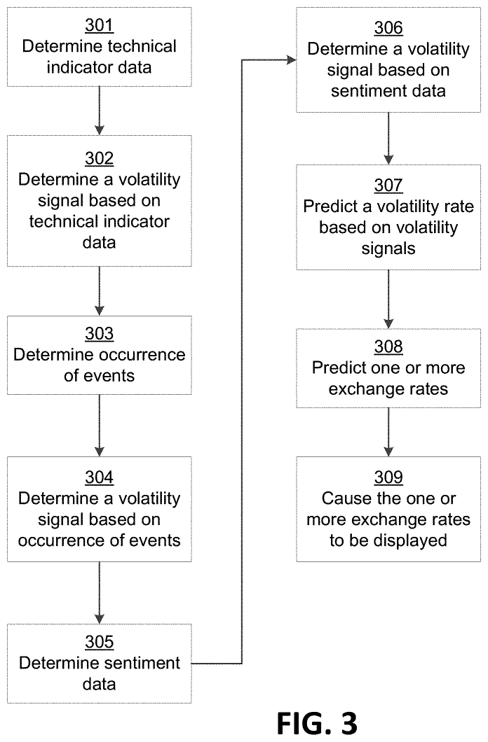

FIG. 3 illustrates an example process 300 of predicting one or more exchange rates between currencies based on a determined volatility and causing the exchange rates to be displayed using a computing device executing an instance of the volatility prediction application, such as client 110 executing volatility prediction application 222 of FIG. 2. For explanatory purposes, the example process 300 is described herein with reference to the processors 212 and 236 of FIG. 2. However, the example process 300 is not limited to the processors 212 and 236 of FIG. 2, and one or more blocks of the example process 300 may be performed by one or more other components of the server 130, including technical indicator engine 240, event data engine 242, sentiment analysis engine 244, volatility prediction engine 246. Further for explanatory purposes, the blocks of the example process 300 are described herein as occurring in serial, or linearly. However, multiple blocks of the example process 300 may occur in parallel. In addition, the blocks of the example process 300 need not be performed in the order shown and/or one or more of the blocks of the example process 300 need not be performed. For purposes of explanation of the subject technology, the process 300 will be discussed in reference to FIG. 2.

At step 301, the technical indicator engine 240 of server 130 determines technical indicator data for a currency pair. The server 130 may receive each currency of the currency pair as user input from a user, such as a user 170. In some implementations, the server 130 may be configured to receive each of the currencies of the currency pair via a graphical user interface (GUI) of an instance of the volatility prediction application 222 being executed on a client device of the user, such as a client device 110 of the user 170. As described above, examples of technical indicator data include, but are not limited to, average true range indicators, Bollinger band width indicators, force index indicators. The server 130 may be configured to determine technical indicator data for a currency pair based on exchange rate data of the currency pair over a certain period of time. For example, the server 130 may be configured to determine average true range indicator data for the currency pair of a United States dollar and a euro, based on changes exchange rates between the dollar and the euro over the last fourteen days.

In some implementations, the server 130 may receive a time period from a user, by the end of which, the user desires to know a prediction of volatility for exchange rates of a currency pair, and the server 130 may be configured to identify historical exchange rate data of the currency pair over a time period that matches the time period received from the user, and determine technical indicator data based on the historical exchange rate data of the currency pair for the time period. For example, if a user 170 desired to know the volatility for a currency pair 30 days from a current day, then the server 130 may be configured to identify historical exchange rate data for that currency pair over the past 30 days and determine a technical indicator data based on the identified historical exchange rate data of the currency pair.

At step 302, the server 130 may be configured to determine a volatility signal for the currency pair based on the technical indicator data. In some implementations, the volatility signal may indicate whether volatility for the currency pair will be higher, lower, or moderate over a certain time period, such as the time period received from the user. In some implementations, the volatility signal may be a value that indicates an expected change in the exchange rate of the currency pair. In some implementations, the server 130, based on changes in the exchange rate data, may be configured to determine a change in the exchange rate over a certain time period and determine volatility for the exchange rate based on changes in the exchange rate.

At step 303, the server 130 may be configured to determine whether one or more economic events may occur. The server 130 may be configured to determine whether the one or more economic events may occur over a certain time period in the future. In some implementations, the server 130 may be configured to determine whether one or more economic events may occur over the time period received from a user 170. As described above, the server 130 may be configured to determine whether an economic event may occur based on economic events data received from a data source. In some implementations, the economic events data may specify one or more dates on which the economic event will occur, and the server 130 may be configured to determine whether the events will occur within the time period in the future. In some implementations, the server 130 may be configured to determine whether a specified date on which an economic event may occur is within the time period in the future.

At step 304, the server 130 may be configured to determine a volatility signal based on the occurrence of economic events. In some implementations, the volatility signal determined based on the occurrence of economic events may indicate whether volatility for the currency pair will be higher, lower, or moderate over a certain time period, such as the time period received from the user. The server 130, via the event data engine 242, may be configured to determine whether volatility increased, decreased, or stayed somewhat same, based on changes in volatility when the economic event occurred previously. In some implementations, the volatility signal determined based on the occurrence of economic events may be a value that indicates a change in the rate of volatility for the currency pair. The server 130 may determine the value in that indicates the change in the rate of volatility based on previous changes in volatility after such economic events occurred.

At step 305, the server 130 may be configured to determine sentiment data. As described above, the sentiment data may be based on portfolio positions of certain trading users whose associated risk rating is above a threshold risk level. The server 130 may be configured to determine sentiment data based on whether any changes in the currency assets accumulated or owned by these trading users within a certain time period satisfy a threshold level of changes. The server 130 may be configured to determine sentiment data as likely volatile if the changes in the currency assets accumulated or owned by the trading users satisfy the threshold level of changes, and not likely volatile if the changes in the currency assets do not satisfy the threshold level of changes. At step 306, the server 130 determines a volatility signal based on sentiment data. As described above, the volatility signal determined based on sentiment data may indicate whether volatility for the currency pair will be higher, lower, or moderate.

At step 307, the server 130, via the volatility prediction engine 246, predicts a volatility rate based on volatility signals. For example, the server 130, via the volatility prediction engine 246, may be configured to determine a volatility rate based on one or more of the volatility signals determined based on technical indicator data, occurrence of economic events, and/or sentiment data. As described above, the volatility prediction engine 246 may be configured to use one or more artificial intelligence trained models in predicting volatilities. In some implementations, the server 130, via the volatility prediction engine 246, may be configured to determine a change in the volatility relative to a current volatility rate of the exchange rate for the currency pair. As described above, the volatility prediction engine 246 may be configured to receive current volatility rate for the exchange rate of a currency pair as an input to one or more artificial intelligence trained models, and based on other inputs to the artificial intelligence trained models, such as the volatility signals, predict a volatility rate at the end of the time period received from the user.

At step 308, the server 130, via the volatility prediction engine 246, predicts one or more exchange rates for the currency pair. The server 130, via the volatility prediction engine 246, may be configured to predict the one or more exchange rates for the currency pair based on the predicted volatility for the currency pair. In some implementations, the server 130, via the volatility prediction engine 246, may be configured to predict one or more exchange rates for the currency pair at the end of the time period received from the user. The server 130, via the volatility prediction engine 246, may be configured to predict the one or more exchange rates for the currency pair based on a current exchange rate for the currency pair and the predicted volatility.

At step 309, the server 130 may cause the one or more exchange rates to be displayed on the graphical user interface displayed on a computing device. For example, the server 130 may cause the one or more exchange rates to be displayed on the graphical user interface displayed on the client device 110 of the user 170. The graphical user interface may be a graphical user interface of the volatility prediction application being executed on the computing device of the user, such as client 110 of user 170. In some implementations, the server 130 may be configured to determine a likelihood of each of the one or more predicted exchange rates occurring or being available at the end of the received time period. In some implementations, the server 130 may be configured to cause the likelihood of each of the one or more predicted exchange rates occurring and the corresponding exchange rates to be displayed on the graphical user interface. In some implementations, the server 130 may be configured to identify a best exchange rate for each of the currencies in the currency pair, and cause the likelihood of those exchange rates occurring along with the identified best exchange rate on the graphical user interface.

In some implementations, the server 130 may be configured to identify worst exchange rate for each of the currencies in the currency pair, and cause the likelihood of those exchange rates occurring along with the identified worst exchange rates on the graphical user interface. In some implementations, the server 130 may receive one or more user inputs that indicate that one of the currencies in the currency pair is a base currency and the other currency in the currency pair as the exposed currency, and the server 130 may be configured to identify a best and a worst exchange rates for the base currency among the one or more predicted exchange rates for the currency pair, determine a likelihood of the best exchange rate and a likelihood of the worst exchange rate, and cause the likelihood of the best exchange rate occurring at the end of the received time period along with the best exchange rate, and the likelihood of the worst exchange rate occurring at the end of the received time period along with the worst exchange rate on the graphical user interface.

### Hardware Overview

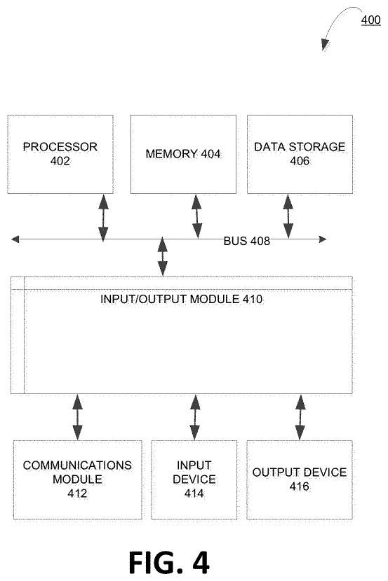

FIG. 4 is a block diagram illustrating an example computer system 400 with which a client 110, such as client 110a, client 110b, client 110c, or client 110d, and a server 130, such as server 130a, and/or server 130b, of FIG. 2 can be implemented. In certain aspects, the computer system 400 may be implemented using hardware or a combination of software and hardware, either in a dedicated server, or integrated into another entity, or distributed across multiple entities.

Computer system 400 (e.g., client 110a, and server 130) includes a bus 408 or other communication mechanism for communicating information, and a processor 402 (e.g., processor 212, 252, 236) coupled with bus 408 for processing information. According to one aspect, the computer system 400 can be a cloud computing server of an IaaS that is able to support PaaS and SaaS services. According to one aspect, the computer system 400 is implemented as one or more special-purpose computing devices. The special-purpose computing device may be hard-wired to perform the disclosed techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices, or any other device that incorporates hard-wired and/or program logic to implement the techniques. By way of example, the computer system 400 may be implemented with one or more processors 402. Processor 402 may be a general-purpose microprocessor, a microcontroller, a Digital Signal Processor (DSP), an ASIC, a FPGA, a Programmable Logic Device (PLD), a controller, a state machine, gated logic, discrete hardware components, or any other suitable entity that can perform calculations or other manipulations of information.

Computer system 400 can include, in addition to hardware, code that creates an execution environment for the computer program in question, e.g., code that constitutes processor firmware, a protocol stack, a database management system, an operating system, or a combination of one or more of them stored in an included memory 404 (e.g., memory 220, and 232), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 408 for storing information and instructions to be executed by processor 402. The processor 402 and the memory 404 can be supplemented by, or incorporated in, special purpose logic circuitry. Expansion memory may also be provided and connected to computer system 400 through input/output module 410, which may include, for example, a SIMM (Single In Line Memory Module) card interface. Such expansion memory may provide extra storage space for computer system 400, or may also store applications or other information for computer system 400. Specifically, expansion memory may include instructions to carry out or supplement the processes described above, and may include secure information also. Thus, for example, expansion memory may be provided as a security module for computer system 400, and may be programmed with instructions that permit secure use of computer system 400. In addition, secure applications may be provided via the SIMM cards, along with additional information, such as placing identifying information on the SIMM card in a non-hackable manner.

The instructions may be stored in the memory 404 and implemented in one or more computer program products, e.g., one or more modules of computer program instructions encoded on a computer readable medium for execution by, or to control the operation of, the computer system 400, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, with languages, embeddable languages, and xml-based languages. Memory 404 may also be used for storing temporary variable or other intermediate information during execution of instructions to be executed by processor 402.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network, such as in a cloud-computing environment. The processes and logic flows described in this specification can be performed by one or more programmable processors executing one or more computer programs to perform functions by operating on input data and generating output.

Computer system 400 further includes a data storage device 406 such as a magnetic disk or optical disk, coupled to bus 408 for storing information and instructions. Computer system 400 may be coupled via input/output module 410 to various devices (e.g., input device 216, output device 214). The input/output module 410 can be any input/output module. Example input/output modules 410 include data ports such as USB ports. In addition, input/output module 410 may be provided in communication with processor 402, so as to enable near area communication of computer system 400 with other devices. The input/output module 410 may provide, for example, wired communication in some implementations, or wireless communication in other implementations, and multiple interfaces may also be used. The input/output module 410 is configured to connect to a communications module 412. Example communications modules 412 (e.g., communications module 218, 258, and 238) include networking interface cards, such as Ethernet cards and modems.

The components of the system can be interconnected by any form or medium of digital data communication (e.g., a communication network). The communication network (e.g., communication network 150) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

For example, in certain aspects, communications module 412 can provide a two-way data communication coupling to a network link that is connected to a local network. Wireless links and wireless communication may also be implemented. Wireless communication may be provided under various modes or protocols, such as GSM (Global System for Mobile Communications), Short Message Service (SMS), Enhanced Messaging Service (EMS), or Multimedia Messaging Service (MMS) messaging, CDMA (Code Division Multiple Access), Time division multiple access (TDMA), Personal Digital Cellular (PDC), Wideband CDMA, General Packet Radio Service (GPRS), or LTE (Long-Term Evolution), among others. Such communication may occur, for example, through a radio-frequency transceiver. In addition, short-range communication may occur, such as using a BLUETOOTH, WI-FI, or other such transceiver.

In any such implementation, communications module 412 sends and receives electrical, electromagnetic, or optical signals that carry digital data streams representing various types of information. The network link typically provides data communication through one or more networks to other data devices. For example, the network link of the communications module 412 may provide a connection through local network to a host computer or to data equipment operated by an Internet Service Provider (ISP). The ISP in turn provides data communication services through the world wide packet data communication network now commonly referred to as the “Internet.” The local network and Internet both use electrical, electromagnetic, or optical signals that carry digital data streams. The signals through the various networks and the signals on the network link and through communications module 412, which carry the digital data to and from computer system 400, are example forms of transmission media.

Computer system 400 can send messages and receive data, including program code, through the network(s), the network link, and communications module 412. In the Internet example, a server might transmit a requested code for an application program through the Internet, the ISP, the local network, and communications module 412. The received code may be executed by processor 402 as it is received, and/or stored in data storage 406 for later execution.

In certain aspects, the input/output module 410 is configured to connect to a plurality of devices, such as an input device 414 (e.g., input device 216) and/or an output device 416 (e.g., output device 214). Example input devices 414 include a keyboard and a pointing device, e.g., a mouse or a trackball, by which a user can provide input to the computer system 400. Other kinds of input devices 414 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Example output devices 416 include display devices, such as an LED (light emitting diode), CRT (cathode ray tube), LCD (liquid crystal display) screen, a TFT LCD (Thin-Film-Transistor Liquid Crystal Display) or an OLED (Organic Light Emitting Diode) display, for displaying information to the user. The output device 416 may comprise appropriate circuitry for driving the output device 416 to present graphical and other information to a user.

According to one aspect of the present disclosure, the client 110A can be implemented using a computer system 400 in response to processor 402 executing one or more sequences of one or more instructions contained in memory 404. Such instructions may be read into memory 404 from another machine-readable medium, such as data storage device 406. Execution of the sequences of instructions contained in main memory 404 causes processor 402 to perform the process steps described herein. One or more processors in a multi-processing arrangement may also be employed to execute the sequences of instructions contained in memory 404. Processor 402 may process the executable instructions and/or data structures by remotely accessing the computer program product, for example by downloading the executable instructions and/or data structures from a remote server through communications module 412 (e.g., as in a cloud-computing environment). In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. For example, some aspects of the subject matter described in this specification may be performed on a cloud-computing environment. Accordingly, in certain aspects, a user of systems and methods as disclosed herein may perform at least some of the steps by accessing a cloud server through a network connection. Further, data files, circuit diagrams, performance specifications, and the like resulting from the disclosure may be stored in a database server in the cloud-computing environment, or may be downloaded to a private storage device from the cloud-computing environment.

Computing system 400 can include clients and servers. A client and server are generally remote from each other and typically interact through a communication network. The relationship of client and server arises by virtue of computer programs running on the respective computers and having a client-server relationship to each other. Computer system 400 can be, for example, and without limitation, a desktop computer, laptop computer, or tablet computer. Computer system 400 can also be embedded in another device, for example, and without limitation, a mobile telephone, a personal digital assistant (PDA), a mobile audio player, a Global Positioning System (GPS) receiver, and/or a television set top box.

The term “machine-readable storage medium” or “computer-readable medium” as used herein refers to any medium or media that participates in providing instructions or data to processor 402 for execution. The term “storage medium” as used herein refers to any non-transitory media that store data and/or instructions that cause a machine to operate in a specific fashion. Such a medium may take many forms, including, but not limited to, non-volatile media, volatile media, and transmission media. Non-volatile media include, for example, optical disks, magnetic disks, or flash memory, such as data storage device 406. Volatile media include dynamic memory, such as memory 404. Transmission media include coaxial cables, copper wire, and fiber optics, including the wires that comprise bus 408. Common forms of machine-readable media include, for example, a floppy disk, a flexible disk, a hard disk, magnetic tape, any other magnetic medium, a CD-ROM, a DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used in this specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire, and fiber optics, including the wires that comprise bus 408. Transmission media can also take the form of acoustic or light waves, such as those generated during radio-wave and infra-red data communications. Furthermore, as used in this specification of this application, the terms “computer,” “server,” “processor,” and “memory” all refer to electronic or other technological devices. These terms exclude people or groups of people. For the purposes of the specification, the terms display or displaying means displaying on an electronic device.

In one aspect, a method may be an operation, an instruction, or a function and vice versa. In one aspect, a clause or a claim may be amended to include some or all of the words (e.g., instructions, operations, functions, or components) recited in other one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first, second, and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately, or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method comprising:
receiving, via a graphical user interface, a first user input for a first currency;
receiving, via the graphical user interface, a second user input for a second currency;
receiving, via the graphical user interface, a third user input for a first time period;
determining, based on a technical indicator data associated with an exchange rate between the first and the second currency, a first volatility for the exchange rate;
determining, based on one or more economic events data, a second volatility for the exchange rate;
determining, based on a sentiment indicator associated with the exchange rate between the first and the second currency, a third volatility for the exchange rate;
determining, based on the first, second, and the third volatilities, a fourth volatility for the exchange rate at an end of the first time period;
predicting, based on the fourth volatility, one or more exchange rates between the first currency and the second currency at the end of the first time period; and
causing the one or more exchange rates between the first currency and the second currency to be displayed on the graphical user interface.

2. The computer-implemented method of claim 1, further comprising:
identifying, from among the one or more exchange rates, a highest exchange rate for the first currency; and determining, based on the fourth volatility, a likelihood of the highest exchange rate occurring at the end of the first time period.

3. The computer-implemented method of claim 2, further comprising:
causing the highest exchange rate and the likelihood of the highest exchange rate occurring on the graphical user interface.

4. The computer-implemented method of claim 1, further comprising:
identifying, from among the one or more exchange rates, a lowest exchange rate for the first currency; and
determining, based on the fourth volatility, a likelihood of the lowest exchange rate occurring at the end of the first time period.

5. The computer-implemented method of claim 4, further comprising:
causing the lowest exchange rate and the likelihood of the lowest exchange rate occurring on the graphical user interface.

6. The computer-implemented method of claim 1, further comprising:
determining one or more changes in the exchange rate between the first currency and the second currency over a second time period;
associating each of the one or more changes in the exchange rate with a portion of the second time period; and
generating, based on the one or more changes in the exchange rate and the associated portions of the second time period, the technical indicator data.

7. The computer-implemented method of claim 1, further comprising:
calculating a change in currency assets owned by a first set of users:
determining whether the change in currency assets owned by the first set of users satisfies a threshold change level; and
in response to determining that the change satisfies the threshold change level:
setting the sentiment indicator to indicate an increase in volatility of the exchange rate between the first currency and the second currency.

8. The computer-implemented method of claim 7, wherein a risk level associated with each user among the first set of users satisfies a threshold risk level.

9. A system comprising:
a memory storing sequences of instructions; and
a processor configured to execute the sequences of instructions, which when executed, causes the processor to perform:
receiving, via a graphical user interface, a first user input for a first currency;
receiving, via the graphical user interface, a second user input for a second currency;
determining, based on a technical indicator data associated with an exchange rate between the first and the second currency, a first volatility for the exchange rate;
determining, based on one or more economic events data, a second volatility for the exchange rate;
determining, based on a sentiment indicator associated with the exchange rate between the first and the second currency, a third volatility for the exchange rate;
determining, based on the first, second, and the third volatilities, a fourth volatility for the exchange rate at an end of a first time period;
predicting, based on the fourth volatility, one or more exchange rates between the first currency and the second currency at the end of the first time period; and
causing the one or more exchange rates between the first currency and the second currency to be displayed on the graphical user interface.

10. The system of claim 9, further comprising stored sequences of instructions, which when executed by the processor, cause the processor to perform:
identifying, from among the one or more exchange rates, a highest exchange rate for the first currency; and
determining, based on the fourth volatility, a likelihood of the highest exchange rate occurring at the end of the first time period.

11. The system of claim 10, further comprising stored sequences of instructions, which when executed by the processor, cause the processor to perform:
causing the highest exchange rate and the likelihood of the highest exchange rate occurring on the graphical user interface.

12. The system of claim 9, further comprising stored sequences of instructions, which when executed by the processor, cause the processor to perform:
identifying, from among the one or more exchange rates, a lowest exchange rate for the first currency; and determining, based on the fourth volatility, a likelihood of the lowest exchange rate occurring at the end of the first time period.

13. The system of claim 12, further comprising stored sequences of instructions, which when executed by the processor, cause the processor to perform:
causing the lowest exchange rate and the likelihood of the lowest exchange rate occurring on the graphical user interface.

14. The system of claim 9, further comprising stored sequences of instructions, which when executed by the processor, cause the processor to perform:
determining one or more changes in the exchange rate between the first currency and the second currency over a second time period;
associating each of the one or more changes in the exchange rate with a portion of the second time period; and
generating, based on the one or more changes in the exchange rate and the associated portions of the second time period, the technical indicator data.

15. The system of claim 9, further comprising stored sequences of instructions, which when executed by the processor, cause the processor to perform:
calculating a change in currency assets owned by a first set of users:
determining whether the change in currency assets owned by the first set of users satisfies a threshold change level; and
in response to determining that the change satisfies the threshold change level:
setting the sentiment indicator to indicate an increase in volatility of the exchange rate between the first currency and the second currency.

16. The system of claim 15, wherein a risk level associated with each user among the first set of users satisfies a threshold risk level.

17. A non-transitory machine-readable storage medium comprising machine-readable instructions, which when executed by a processor, cause the processor to perform a method comprising:
receiving, via a graphical user interface, a first user input for a first currency;
receiving, via the graphical user interface, a second user input for a second currency;
receiving, via the graphical user interface, a third user input for a first time period;
determining, based on a technical indicator data associated with an exchange rate between the first and the second currency, a first volatility for the exchange rate;
determining, based on one or more economic events data, a second volatility for the exchange rate;
determining, based on a sentiment indicator associated with the exchange rate between the first and the second currency, a third volatility for the exchange rate;
determining, based on the first, second, and the third volatilities, a fourth volatility for the exchange rate at an end of the first time period;
predicting, based on the fourth volatility, one or more exchange rates between the first currency and the second currency at the end of the first time period; and
causing the one or more exchange rates between the first currency and the second currency to be displayed on the graphical user interface.

18. The non-transitory machine-readable storage medium of claim 17, further comprising:
identifying, from among the one or more exchange rates, a highest exchange rate for the first currency; and
determining, based on the fourth volatility, a likelihood of the highest exchange rate occurring at the end of the first time period.

19. The non-transitory machine-readable storage medium of claim 18, further comprising:
causing the highest exchange rate and the likelihood of the highest exchange rate occurring on the graphical user interface.

20. The non-transitory machine-readable storage medium of claim 17, further comprising:
identifying, from among the one or more exchange rates, a lowest exchange rate for the first currency;
determining, based on the fourth volatility, a likelihood of the lowest exchange rate occurring at the end of the first time period; and
causing the lowest exchange rate and the likelihood of the lowest exchange rate occurring on the graphical user interface.
